(19) United States
(12) Patent Application Publication
(10) Pub. No.: US 2010/0191701 A1
(43) Pub. Date: Jul. 29, 2010

(54) SYSTEM AND METHOD FOR MANAGING A BUSINESS PROCESS AND BUSINESS PROCESS CONTENT

(75) Inventors: Peter Beyda, Franklin Lakes, NJ (US); Chris Katsikas, Flushing, NY (US); Kasoon Chapman, Hackensack, NJ (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/359,059

(22) Filed: Jan. 23, 2009

(51) Int. Cl. G06F 3/048; G06F 17/30

(52) U.S. Cl. 707/608; 715/738; 707/E17.017

(57) ABSTRACT

Aspects of the invention relate to a method and system to manage a business process and business process content, comprising a content management system that includes efficiency-improving and workflow features. Efficiency-improving features allow several people involved in a business process, including those residing in different locations, to store and access documents in a central repository of a content management system. Further, these features manage business process content that include functions such as document handling and searching capabilities that allow users to navigate, search, and develop business content efficiently. In addition, the business process becomes a virtual electronic environment without the need for redundant physical files spread throughout different offices. Alternatively, workflow features allow personnel involved upstream of the business process to record and complete their own tasks, and then annotate and route documents to downstream personnel to facilitate their tasks as part of the business process.

### FIELD OF THE INVENTION

The invention generally relates to a system and method for electronically managing a business process and business process content. Particularly, the invention relates to electronic systems and methods that facilitate the workflow of a business process and manage business process content.

### BACKGROUND OF THE INVENTION

Many business processes require coordinating the activities of several different people who are often spread across different locations. Documents generated and handled during such a business process can become voluminous and cumbersome to manage. Further, managing the business process workflow from one person to the next can also be challenging in such a work environment. An example of such a business process is an insurance claim adjustment process.

### BRIEF SUMMARY OF THE INVENTION

Aspects of the invention relate to a method and system to electronically manage a business process and business process content comprising a content management system that includes efficiency-improving and workflow features. Efficiency-improving features can allow several people involved in an electronic business process, including those residing in different locations, to store and access documents in a central repository of a content management system. Further, efficiency-improving features can allow for the management of business process content including functions such as document handling and searching capabilities that allow users to navigate, search, and develop business content efficiently. In addition, the business process can become a virtual electronic environment without the need for redundant physical files spread throughout different offices. Workflow features can allow personnel involved upstream of the business process to record and complete their own tasks, and then annotate and route documents to downstream personnel to facilitate their tasks as part of the business process.

In one embodiment for an insurance claim adjusting process, an insurance claim adjuster may investigate an incident scene, draft a report of the incident and store it in a content management system using efficiency-improving features. The claim adjuster can manage the workflow of the insurance claim adjustment process by annotating and routing the document within content management system downstream to a claim analyst within the insurance company. The claim analyst can review the adjuster's incident report and determine an amount to pay the insurance claimant.

Aspects of the invention include a system for managing a business process and business process content, the system comprising a communication network and a computer server connected to the communication network. The system further comprising an electronic central repository, connected to the computer server, the computer server being programmed to store business process content files into the electronic central repository. In addition, the computer server is adapted to execute a management and workflow software application, the management and workflow software application having a management software module for accessing and organizing business process content files by a user and a workflow software module for notifying a different user to produce business process content files and routing business process content files to the different user. The computer server is further adapted to present a electronic user interface to a client and receive information through the electronic user interface, over the communication network wherein the electronic user interface, provides the user access to the management and workflow software application and business process content files stored in the electronic central repository.

Aspects of the invention include an exemplary method for managing a business process and business process content comprising the steps of invoking a management and workflow software application running on a computer server, the management and workflow software application having a management module and a workflow module and generating a graphical user interface for presenting the management and workflow software application to a user. A further step of the exemplary method may include accessing business process content files using the management module from an electronic central repository. Additional steps of the exemplary method may include notifying a business process participant to produce business process content files using the workflow module, routing business process content files to one or more business process participants using the workflow module, and storing business process content files in the electronic central repository using the management and workflow software application.

### BRIEF DESCRIPTION OF THE SEVERAL VIEWS OF THE DRAWINGS

The advantages of the invention can be understood from the description of embodiments of the invention set forth below with reference to the drawings, in which:

FIG. 1 is a schematic view of system architecture in keeping with the disclosed principles;

FIGS. 2-5 are flow diagrams that illustrate exemplary methods for managing a business process and business process content, according to an aspect of the invention.

FIG. 6 is an exemplary user interface that challenges a user to input credentials, according to an aspect of the invention;

FIG. 7 is an exemplary user interface that allows a user to change the user password and confirm a new password while logging an exemplary system, according to an aspect of the invention;

FIG. 8 is an exemplary user interface that allows a user to manage content in a claim adjustment process;

FIG. 9 is an exemplary user interface that allows a user access to a claim adjustment worklist;

FIG. 10 is an exemplary user interface that allows a user to route business process content from one user's worklist to another user's worklist;

FIG. 11 is an exemplary user interface that allows a user to route business process content from a user interface displaying a list of search results to a worklist;

FIG. 12 is an exemplary user interface that allows a user to create business process content notes;

FIG. 13 is an exemplary user interface that allows a user to e-mail business process content to another contributor in the claim adjustment process;

FIG. 14 is an exemplary user interface that allows a user to import business process content and store it within an exemplary content management system;

FIG. 15 is an exemplary user interface that allows a user to export business process content from an exemplary content management system;

FIGS. 16-17 are exemplary user interfaces for accessing integrated third party software applications that provides a user access to business process content stored in an exemplary content management system;

FIG. 18 is an exemplary user interface that allows the user to suspend producing business process content within an exemplary management system;

FIG. 19 is an exemplary user interface that allows a user to display process status information;

FIG. 20 is a chart of certain preferred search parameters and business process content attributes for several exemplary business process content types;

FIG. 21 is an exemplary user interface that allows a user to search a content management database based on preferred search parameters or attributes;

FIG. 22 is an exemplary user interface that allows a user to select advanced techniques to search for business process content within an exemplary content management system;

FIG. 23 is an exemplary user interface that displays exemplary search results obtained from searching an exemplary content management system, according to an aspect of the invention;

FIG. 24 is an exemplary user interface that displays attributes and allows a user to edit the attributes of a business process content stored in an exemplary content management system;

FIG. 25 is an exemplary user interface that allows a user to filter, search, and organize business process content;

FIG. 26 is an exemplary user interface that allows a user to create an electronic folder within an exemplary content management system;

FIG. 27 is an exemplary user interface that allows a user to check-in and check-out business process content to and from an exemplary content management system;

FIG. 28 is an exemplary user interface that allows a user to delete business process content from an exemplary content management system; and

FIG. 29 is an exemplary user interface that displays the version information of business process content stored in an exemplary content management system.

### DETAILED DESCRIPTION OF THE INVENTION

Aspects of the invention relate to a method and system to electronically manage a business process and business process content, comprising a content management system that includes efficiency-improving and workflow features. A software application having one or more software modules may implement these features. The virtual electronic environment provided by the invention allows instant access to business process files to personnel residing in different locations. These locations may be in different countries, around the world so that the software application and modules may be translated or ported into environments compatible the local computer systems. This may include translating the text displayed on electronic user interfaces to the local spoken language or porting the software application to an analogous technology to be compatible with local computer systems. Further, creating electronic files in an electronic central repository eliminates redundant, lost, or misplaced files located in geographically dispersed offices. In addition, a content management system provides a standardized and streamlined workflow for the business process that delivers a consistent work product and reduces business process cycle time.

An embodiment of the invention may be implemented as part of an insurance claim adjustment process. The workflow of a claim adjustment process may include an insurance incident or loss event arising out of a traffic accident.

Upon such a loss event, an insurance company receives a claim from the insured of the incident or loss event. An insurance claim adjuster is dispatched to the loss event site to assess the damage. The claim adjuster then provides the insurance company with a claim adjustment (value for the loss event) that the insurance company offers to the insured. The insured may accept or dispute the claim adjustment. In some cases, an insured may retain an attorney to dispute the claim adjustment. In such cases, the insurance company employs its own attorney to defend itself against the insured. The conflict may escalate such that a court, mediator, or arbiter resolves the dispute.

There may be many different contributors or process participants involved in the claim adjustment process that contribute different type of content including claim adjuster reports, insured information, litigation documents, court orders, mediation and arbitration documents. The workflow functions of the present invention facilitate the process by delivering work product from one contributor to the next. Efficiency-improving (or management) functions allow each contributor to complete their task and develop their work product (e.g., document, report, video data, audio data, etc.) in a cost-effective and time-saving manner. Each contributor may produce documents and other work product that are organized into one or more claim adjustment files by the insurance company. Further, contributors may be located in different areas and offices adding more complexity in managing the claim adjustment process and its associated content. Therefore, organizing the claim adjustment documents and other work product as well as providing a standard methodology and workflow can help produce a more efficient claim adjustment process.

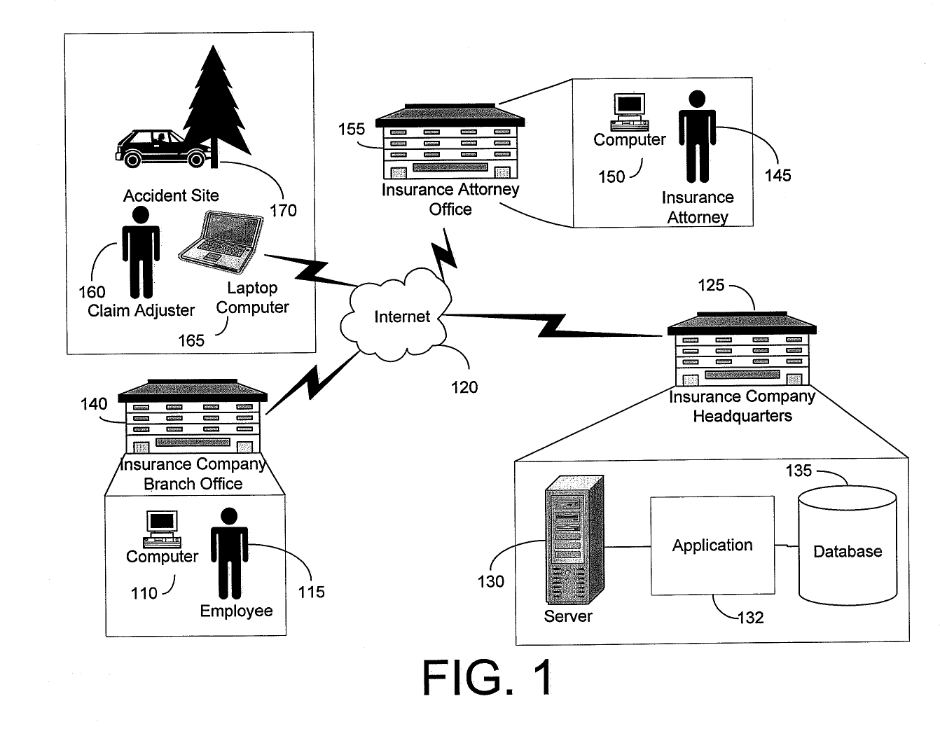

FIG. 1 is a schematic view of system architecture in keeping with the disclosed principles. One or more business process software applications 132 may reside within an insurance company headquarters 125. One or more servers 130 implement a software application 132, which may access one or more databases 135 or an electronic central repository that store business process content. Business process content may include the documents or other work product produced as part of the business process. The servers 130, software application 132, and databases 135 can constitute a content management system. Insurance company employees may be located at the company's headquarters or in a branch office 140. A branch employee 115 may access a software application 132 remotely from a computer 110 across the Internet 120. Similarly, an insurance claim adjuster 160 may remotely access a software application 132 from a laptop or other portable communication or computing device (PDA, mobile phone, etc.) 165 from an accident or loss event site 170. Additional personnel, such as an insurance defense attorney 145, retained by the insurance company during the claim adjustment process, also may have remote access to the software application 132 from his computer 150 within his office 155.

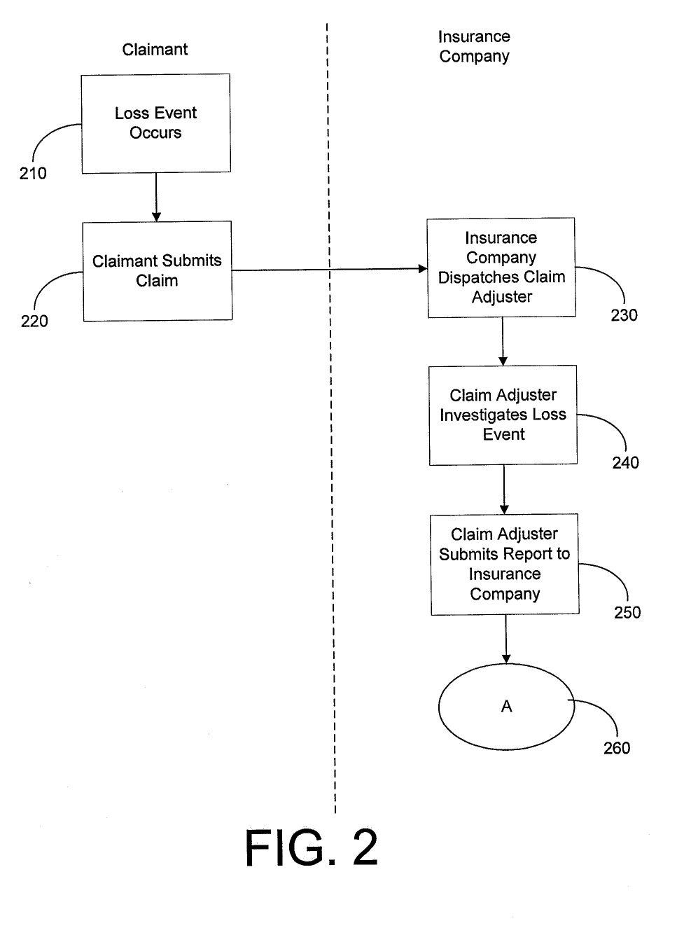

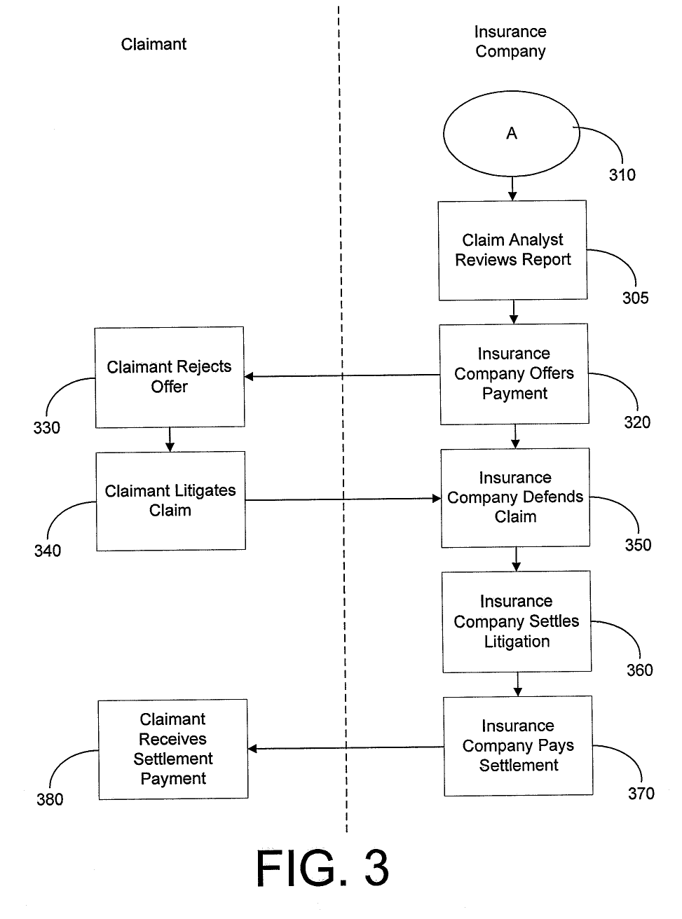

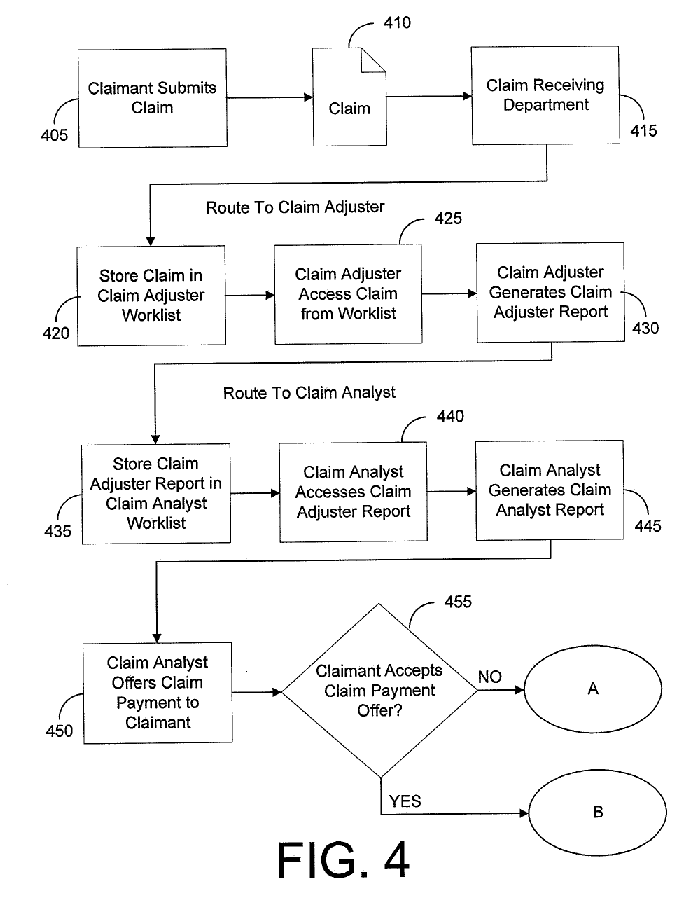

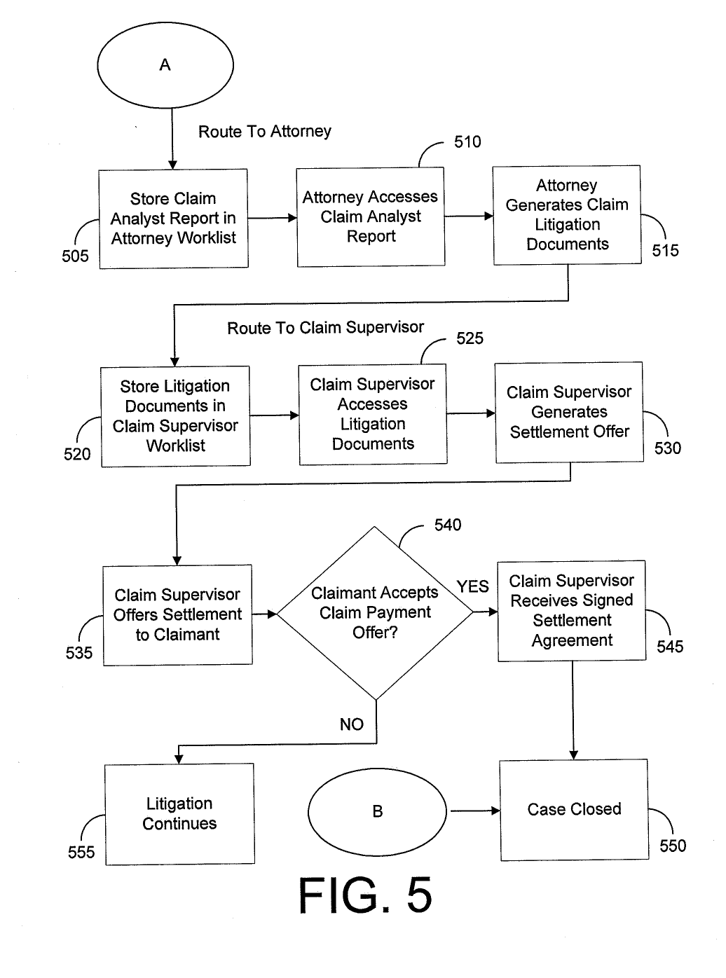

FIGS. 2-5 are flow diagrams that illustrate exemplary methods for managing a business process and business process content, according to an aspect of the invention. The exemplary business processes shown in FIGS. 2-5 are particularly directed to an insurance claim adjustment process. At each step of the business process, workflow features allow an insurance company to manage its employees and their workload so that the submitted claim can be resolved. Many different insurance company personnel participate in, and contribute to, the claim adjustment process, which can result in the production of large amounts of documents, work product, and other business process content. FIGS. 2-3 illustrate an exemplary method for managing a claim adjustment process and its associated content between an insured claimant and an insurance company. FIGS. 4-5 illustrate an exemplary method for managing a claim adjustment process and its associated content within an insurance company.

In FIG. 2, at step 210, the claimant experiences a loss event such as a car accident. At step 220, the claimant submits an insurance claim to the insurance company for the loss event. After receiving the insurance claim, step 230, the insurance company dispatches a claim adjuster to the loss event site to assess the damage. At step 240, the claim adjuster investigates the loss event and drafts a report of the loss event for the insurance company. At step 250, the claim adjuster submits the report to the insurance company.

In FIG. 3, after the insurance company receives the claim adjuster's report, at step 305, a claim analyst reviews the claim adjuster's report to determine the amount of payment to offer the claimant. At step 320, a claim payment coordinator, on behalf of the insurance company, offers a payment to the insured for the claim. To the extent that the insured accepts the offer of payment, the process terminates as usual (not shown). However, the process of FIGS. 2-3 illustrates a series of interactions between an insured and insurer resulting in litigation. The claimant rejects the claim at step 330. The claimant thereafter sues the insurance company and litigates the claim, step 340, against which the insurance company defends itself, step 350. At step 360, the insurance company settles the litigation with the claimant. At step 370, the insurance company pays the settlement to the claimant. At step 380, the claimant receives the settlement payment. If the claimant does not agree to settle, the litigation continues.

FIGS. 4-5 describe the workflow of documents, work product, and other business process content of an electronic claim adjustment process similar to the claim adjustment process described in FIGS. 2-3. Several different features enable a content management system to perform its workflow and management functions, according to an aspect of the invention. One such feature may be a worklist. Each person involved in the claim adjustment process for the insurance company has access to a content management system (CMS) as a user. Upon access, the electronic user interface of the content management system can display a user's worklist. In a preferred embodiment, a worklist is a list of documents stored in the content management system, wherein each document either is stored by the user himself or routed to the user by some other authorized insurance personnel. The routed documents assist the user in completing their task or developing their work product as part of the claim adjustment process. Further, the worklist feature allows the user to organize the different documents and the work product produced as part of the claim adjustment process. Another feature of the CMS is a routing function. A routing function allows an authorized CMS user to route documents from one user's worklist to another user's worklist to facilitate the claim adjustment process. The document annotation function is another CMS feature that allows a person routing a document to provide notes for a recipient regarding a particular document, or the claim adjustment process in general, to assist the recipient to complete his task/work product in the process. These functions facilitate the workflow of the claim adjustment process.

At step 405, a claimant submits a claim 410 to an insurance company. A claim receiving department 415 within the insurance company receives the claim. Thereafter, claim receiving personnel electronically store the claim in a content management system. At step 420, claim receiving personnel uses the CMS routing function to send the electronic copy of the claim to a claim adjuster's worklist. In addition, claim receiving personnel may annotate the claim document with the claim submission date, the description of the loss event, deadlines, etc. At step 425, the claim adjuster accesses his worklist within the CMS and discovers the claim 410 in his worklist. Thereafter, the claim adjuster accesses the claim document and the annotated comments to review the claim. Reviewing the deadlines in the annotations of the claim document may suggest that the claim adjuster submit a claim adjuster report within 30 days of the claim submission date. After investigating the claim, the claim adjuster generates a claim adjuster report, step 430. The claim adjuster routes the claim adjustment report to a claim analyst, step 435, such that the CMS stores it in the claim analyst's worklist. The claim adjuster may annotate the report to summarize or highlight certain aspects such as the replacement cost of estimated damage suffered by the claimant due to the loss event. At step 440, the claim analyst accesses the claim adjuster report from the worklist. The claim analyst reviews the report and its annotations in addition to the claimant's insurance policy. There may be certain exclusions or other conditions within the insurance policy such that the claim analyst adjusts the replacement cost of the estimated damage found by the claim adjuster. At step 445, the claim analyst generates a claim analyst report that includes a payment offer for the claim. The claim analyst, thereafter, offers the claim payment to the claimant, step 450. At a decision 455, the claimant decides whether to accept the offer. If the claimant accepts the offer of payment, the process terminates and the case is closed (See FIGS. 4-5). However, FIGS. 4-5 illustrate the exemplary steps of a process when the claimant rejects the offer of payment, and results in litigation between the claimant and the insurance company. Consequently, an insurance company attorney becomes involved in the process to defend against the litigated claim.

Continuing to FIG. 5, at step 505, the claim analyst routes the claim analyst report to the attorney's worklist. The attorney accesses the claim analyst report from his worklist to review the status of the submitted claim, step 510. In the course of defending the insurance company in the litigation, the attorney generates litigation documents, step 515. The attorney further routes the litigation documents to the worklist of a claim supervisor with annotations for each document, step 520. The claim supervisor accesses and reviews the litigation documents and their annotations, step 525. The claim supervisor has the authority to settle the litigation on behalf of the insurance company. After reviewing the litigation documents, the claim supervisor generates a settlement offer, step 530, which is offered to the claimant, step 535. At decisional 540, the claimant decides whether to accept the offer. If the claimant accepts the offer then, at step 545, the claim supervisor receives the signed settlement agreement from the claimant. At step, 550, the claim supervisor stores the signed settlement agreement and closes the case within the CMS. However, if the claimant rejects the offer, litigation continues as shown in step 555.

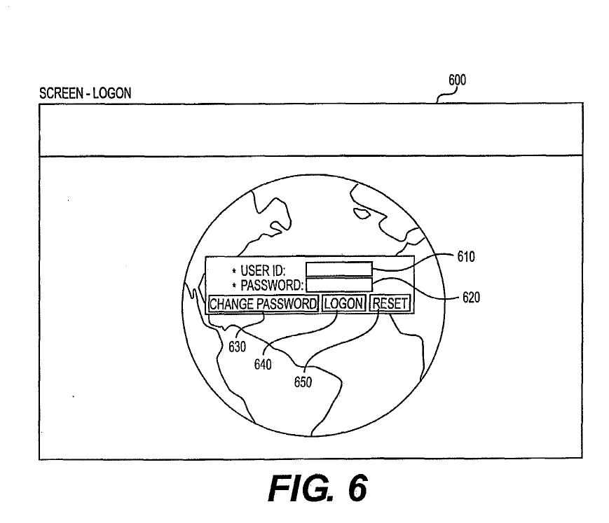

Aspects of the present invention include a system to implement the exemplary methods shown in FIGS. 2-5. These systems may include, but are not limited to a software application having one or more software modules, scripts and functions implementing system features and running on one or more servers that interact with one or more databases as part of an electronic central repository. Contributors involved in a business process, as shown in FIGS. 2-5, may implement and access the software application and databases, respectively, using the following exemplary electronic and/or graphical user interfaces shown in FIGS. 6-29. A person of ordinary skill in the art would understand that the software application, software modules, scripts, and functions shown and described are exemplary and in no way limit aspects of the invention.

FIG. 6 is an exemplary user interface that challenges a user to input credentials, according to an aspect of the invention. The systems and applications, such as server 130 and application 132 (See FIG. 1), challenge attempts to access the virtual electronic environment of a CMS. A user must log into the system with appropriate credentials to manage the content of a claim adjustment process. The user enters a User ID 610 and password 620. A link or pushbutton on a user interface also allows the user to change the user password 630 or reset 650 the User ID or password.

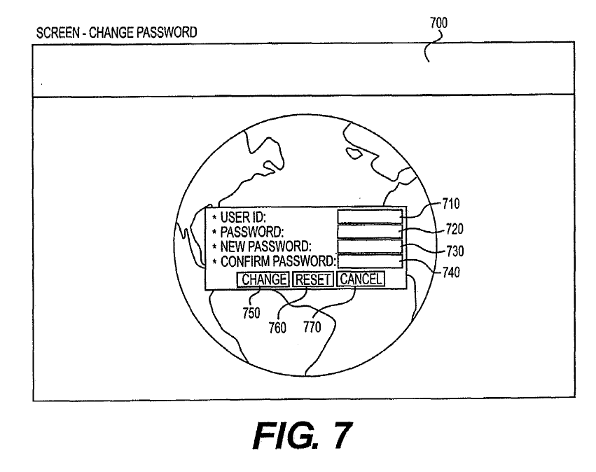

FIG. 7 is an exemplary user interface that allows a user to change the user password and confirm a new password while logging into an exemplary system, according to an aspect of the invention. The system displays an exemplary user interface when a user presses button 630 of user interface 600. This interface allows a user to change the user password (730, 750) and confirm a new password 740 while logging into the system. The user also may reset 760 the data fields shown in FIG. 7 or cancel 770 the operation of changing the user password.

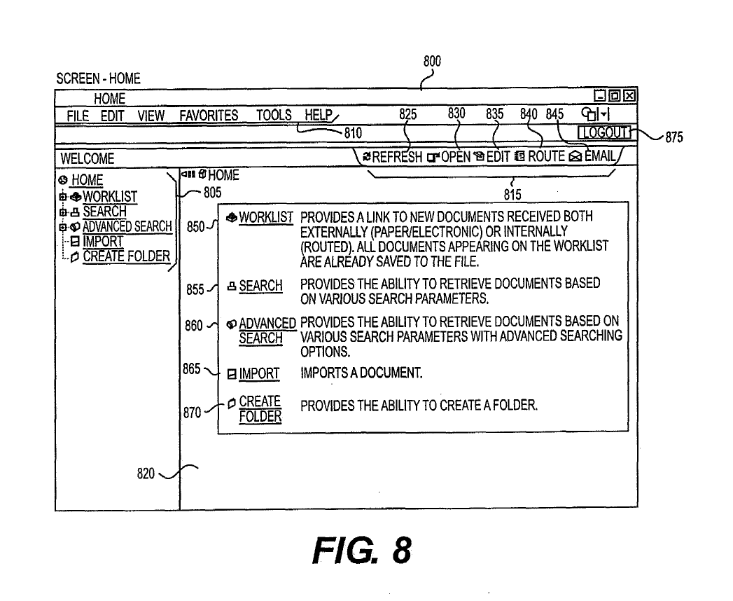

FIG. 8 is an exemplary user interface 800 that allows a user to manage content in a claim adjustment process. The exemplary user interface has a standard drop down menu of functions 810 that provide a user access to the workflow and the efficiency-improving features of a CMS. This includes the user interface 800 having options 815 such as Refresh 825, Open 830, Edit 835, Route 840, and E-mail 845. The exemplary user interface also includes a browser tree 805 to efficiently organize different documents and work products that are involved in the claim adjustment process. The top of the browsing tree is labeled Home. Branches underneath Home 820 include, but are not limited to, Worklist, Search, Advanced Search, Import and Create Folder. There may be sub-branches underneath these branches (denoted by a plus “+” sign). Worklist 850 provides a link to new documents received both externally (paper/electronic) or internally (routed). It also allows the user to organize work product. All documents appearing on the worklist are already saved to one or more claim adjustment files. The Search entry in the browser tree 855 provides the ability to retrieve documents based on various search parameters. Advanced Search 860 provides additional capabilities to retrieve documents based on various search parameters using advanced searching logic. Import entry 865 allows a user to import a document or other work product stored locally on a user's computer into the content management electronic central repositories or databases. The Create a Folder entry in the browser tree allows a user to create an electronic folder to better organize documents and work product pertaining to a claim adjustment file.

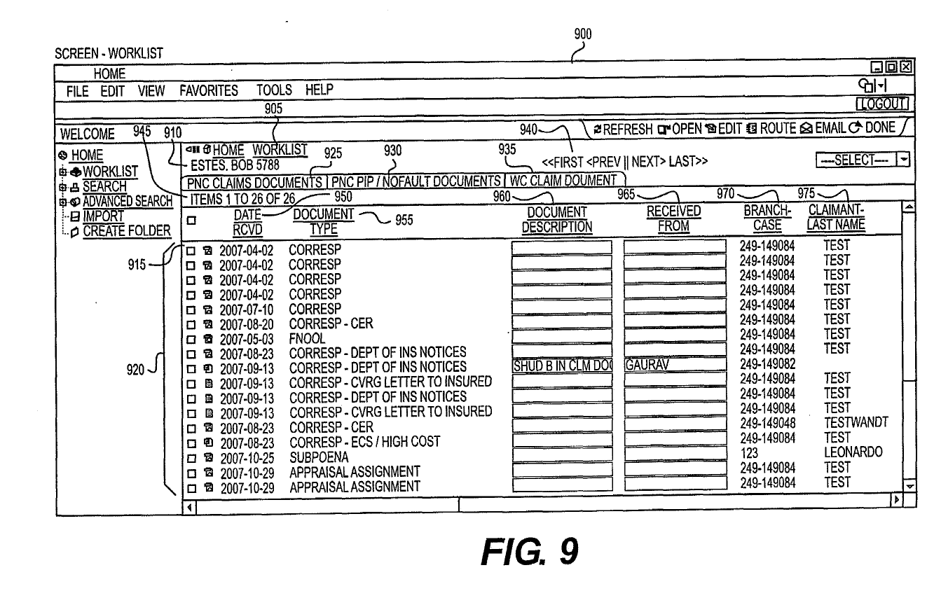

FIGS. 9-19 illustrate workflow features that are that are available to different users or business process participants of an exemplary system, according to aspects of the invention. A software application having one or more software modules may implement the workflow features. FIG. 9 is an exemplary user interface 900 that allows a user access to a claim adjustment worklist 905 feature. Contents of the worklist are visible to the user upon selecting a worklist name from the browser tree. The insurance policy number or claimant name may be part of the worklist name. The insurance policy number may be a hyperlink 910 and an attribute within the worklist. When clicking the insurance policy number hyperlink, all documents for that policy are preferably displayed 925 to the user. The documents may be further organized into different tabs (925, 930, and 935). A document may be selected to be managed (viewed, deleted, edited, searched, routed, e-mailed, etc.) by clicking box 915. The documents are displayed and organized on the user interface in a table with the documents or other work product in rows. The columns of the table display attributes for each document. For example, an icon shows the electronic format of document (pdf, doc, txt, jpeg, etc.). Further attributes include, but are not limited to, dated received 950, document type 955, document description, 960, Received From 965, branch case 970, and claimant last name 975. Document Description 960 and Received From 965 attributes are data entry fields through which a user can input information about the document.

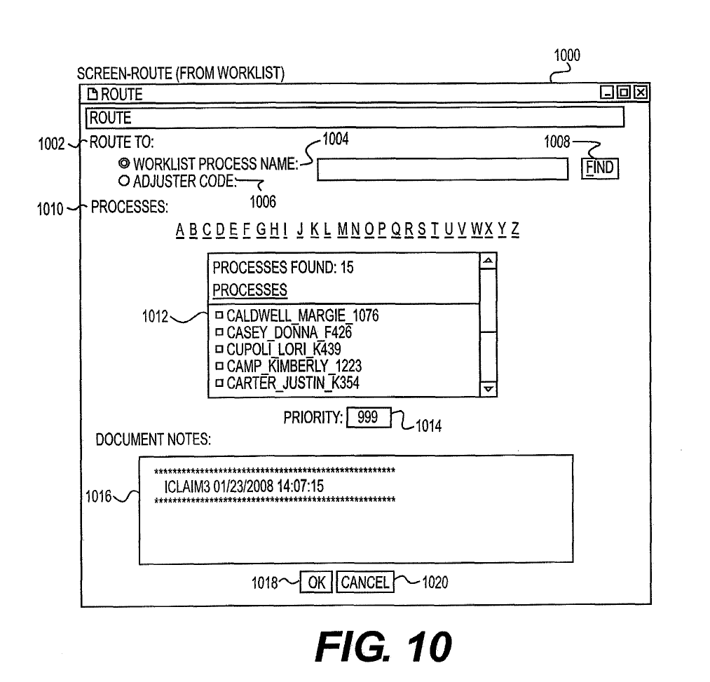

FIG. 10 is an exemplary user interface that allows a user to route business process content from one user's worklist to another worklist. The user interface is displayed from within the worklist screens by clicking the Route Document button on the frequently used option bar (840 and 815) or by selecting the Route function from the dropdown list 810 (See FIG. 8). A user may route one or more documents (or a subfolder) to a destination worklist 1002. Users may select a destination worklist by worklist process name (1004, 1008) or by adjuster code (1006, 1008). Users may search for worklist processes alphabetically within the content management database 1010. Search results are displayed on the user interface 1012. A user may also enter a priority number 1014 to express the level of importance of the routed documents to the recipients. In addition, a user may attach document notes to send to the recipient of the documents 1016. When ready to route the document, a user need only click the OK button 1018. A user may also cancel document routing by clicking the Cancel button. A document may be routed with an annotation providing a reason for routing the document to the recipient. The exemplary system allows a user to route documents to one or more recipients.

When routing a document to one or more different users, a user has the ability to provide graphical as well as written annotations containing relevant information concerning the document. Users may also color code documents to indicate priority. The user interface thereby allows users to modify settings relating to workflow. These customizable settings advantageously enhance workflow processing by having one contributor of the process upstream prioritize tasks to another contributor downstream. Further, users are able to view two documents side by side for comparison. In addition, users can mark documents with attributes such as “read,” “unread,” “review,” later” and “high priority.” Additional functions allow a user to set the screen size to provide optimal viewing of any documents.

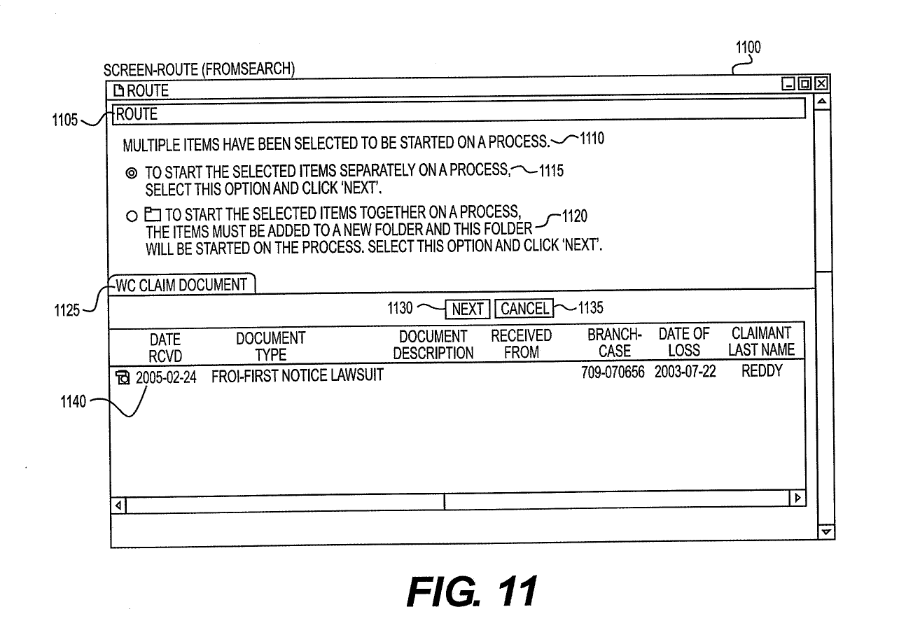

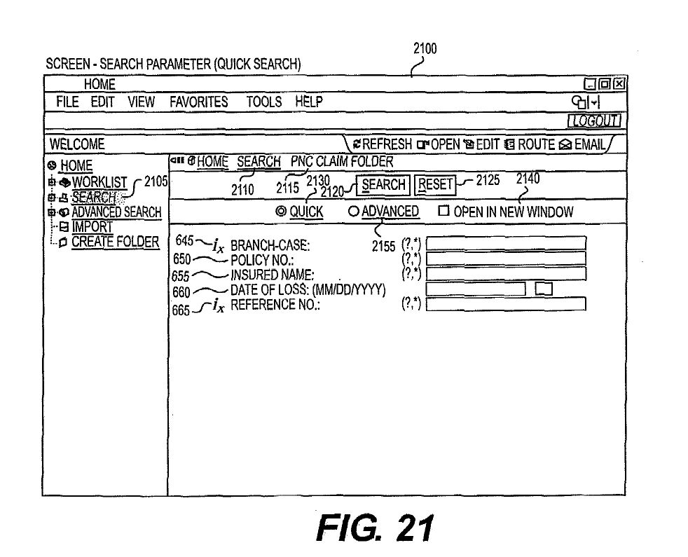

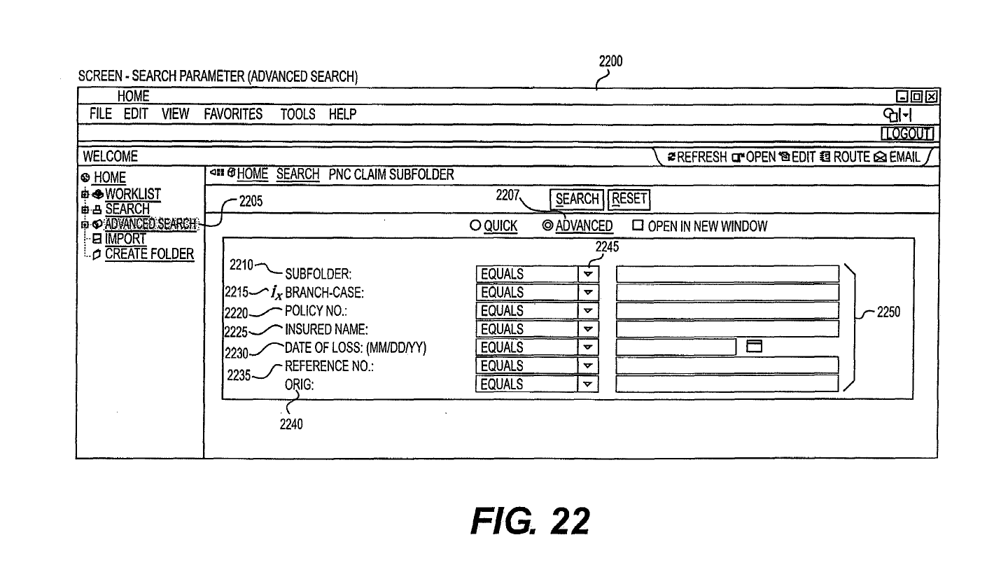

FIG. 11 is an exemplary user interface 1100 that allows a user to route documents from a list of search results to a worklist. The user interface is displayed from within the search results screens (See FIGS. 21-22) by clicking the Route Document button on the frequently used option bar 815 (See FIG. 8) or by selecting the Route function from the drop down list 810 (See FIG. 8). A user may search for documents and then route 1105 them to different worklist processes (1110, 1115) or to the same worklist process (1110, 1120). The user interface shows the documents to be routed (1125, 1140). Clicking the Next pushbutton 1130 routes the documents. Clicking the Cancel button 1135 cancels the action. When performing the Route function, the software application automatically may store the document to another user's worklist. This function may be implemented by a software module that points the recipient's worklist to the memory location of the document in the database or the electronic central repository.

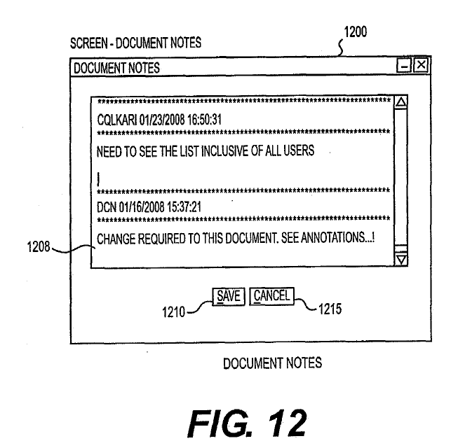

FIG. 12 is an exemplary user interface 1200 that allows a user to create business process content notes 1205. The user interface is displayed upon selecting the document notes option from the drop down list 810 (See FIG. 8). After a user creates document notes, the user may save them to a content management database 1210 that is part of an electronic central repository. Clicking the Cancel button 1215 cancels the action. Notes added to the record associated with the event provide enhanced communications between users. They also provide additional searchable content.

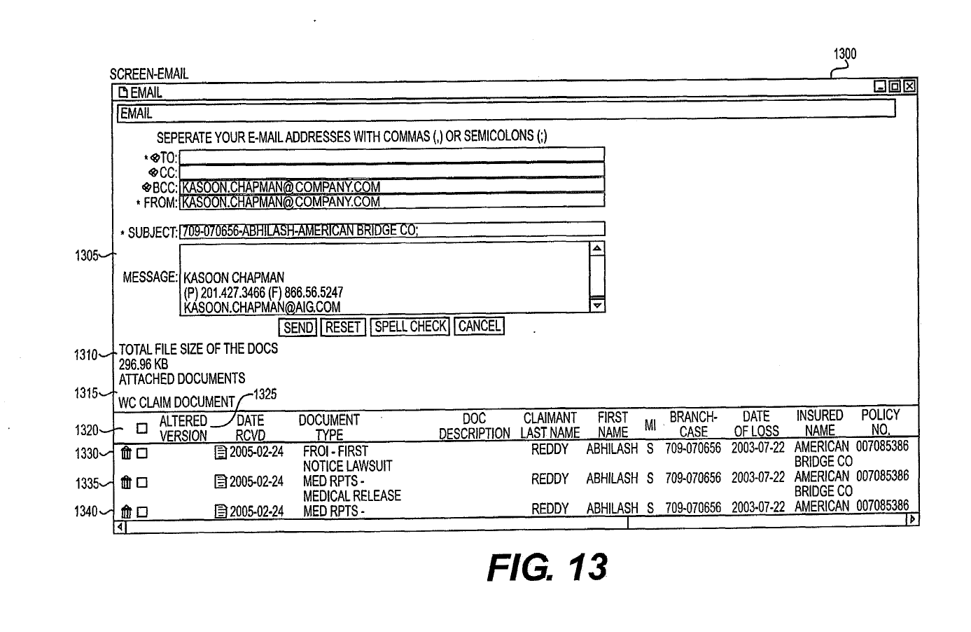

The exemplary user interface 1300 illustrated in FIG. 13 allows a user to e-mail documents to one or more contributors involved in the claim adjustment process. The user interface can be accessed from within the search results (See FIGS. 21-22) and worklist screen (See FIG. 8) by the clicking the E-mail button on the frequently used option bar 815 (See FIG. 8) or by selecting E-mail from the drop down list 810 (See FIG. 8). The user interface has a typical e-mail user interface 1305. Further, the user interface displays the attached documents 1315 and document size 1310. In addition, the user interface displays the documents attributes 1320, including version information 1325 of the document. A list of documents that can be attached to the e-mail is also provided (1330-1340) by the user interface. In addition, the e-mail user interface is integrated with a companywide address book to easily find potential recipients for the e-mailed documents.

FIGS. 10-11 and 13 allow a user to route electronically or email documents to other users or business process participants located in geographically dispersed offices. Further, the exemplary content management system can track the routing and emailing of documents in the electronic claim adjustment file history for future reference and management purposes. These aspects of the invention make a virtual claim adjustment management system more efficient.

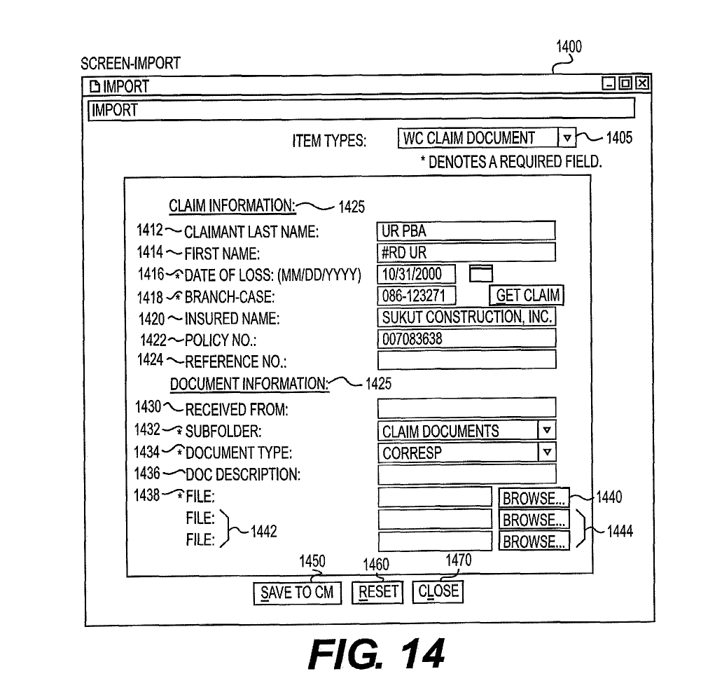

FIG. 14 is an exemplary user interface 1400 that allows a user to import documents and store them within an exemplary content management system. A user may select an item type for the document 1405 and then enter claim information regarding the document 1425. This claim information may include, but is not limited to, claimant last name 1412, first name 1414, date of loss 1416, Branch-case 1418, Insured Name 1420, Policy Number 1422, and Reference Number 1424. A user may also enter document information 1425 that includes, but is not limited to, Received From 1430, Subfolder 1432, Document Type 1434, Document Description 1436, and File 1442. The user interface can import more than one file by browsing resident computer (1440, 1444). When the user is ready or all the necessary information is entered, the user may save the document to the content management system 1450. A user may also reset the information 1460 or close the user interface 1470. Uploading documents from remote computers to a centrally located content management database or electronic repository allows an insurance company to efficiently organize the claim adjustment process by maintaining electronically linked files in a centrally linked database that can be accessed by dispersed participants in the business process. Further, importing documents into a user's worklist facilitates the business process workflow by creating a unified record.

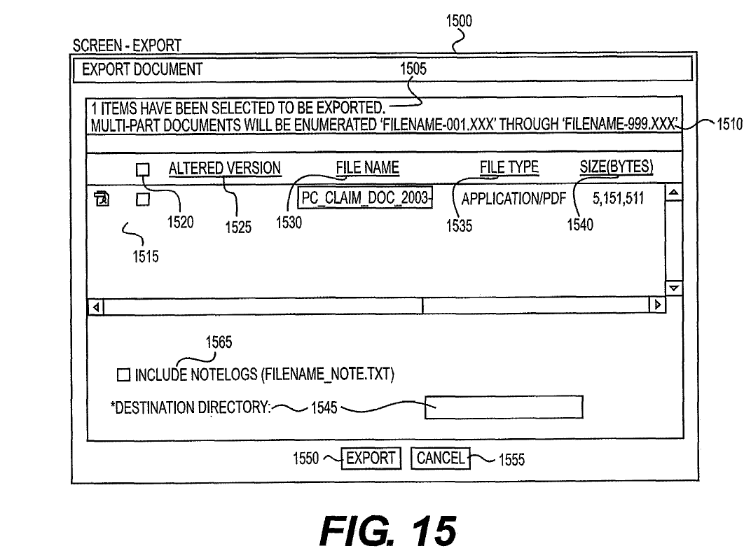

A user may also export documents from an exemplary content management system through user interface 1500, illustrated in FIG. 15. The user interface 1500 is displayed upon selecting the export from within dropdown list 810 (See FIG. 8). A user may export items 1550 to other contributors such as the insured or the insured defense attorney for their files. The user interface displays the number of items to be exported 1505 and whether any items constitute a portion of a multi-part document 1510. The user interface allows a user to export an altered version (1520 and 1525). It also displays the file name 1530, file type 1535, and size of the document 1540. In addition, the user may select a destination directory of the export documents 1545. Users also have the ability to include annotations 1565 when e-mailing and exporting documents. Documents and e-mail recipients may view annotations made to documents even when the documents are sent outside the content management electronic environment.

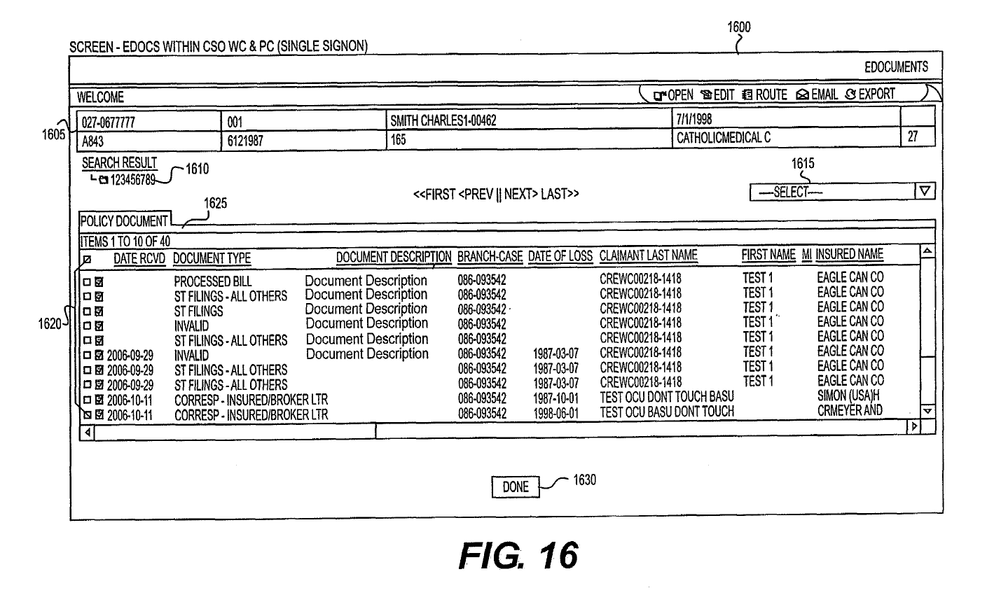

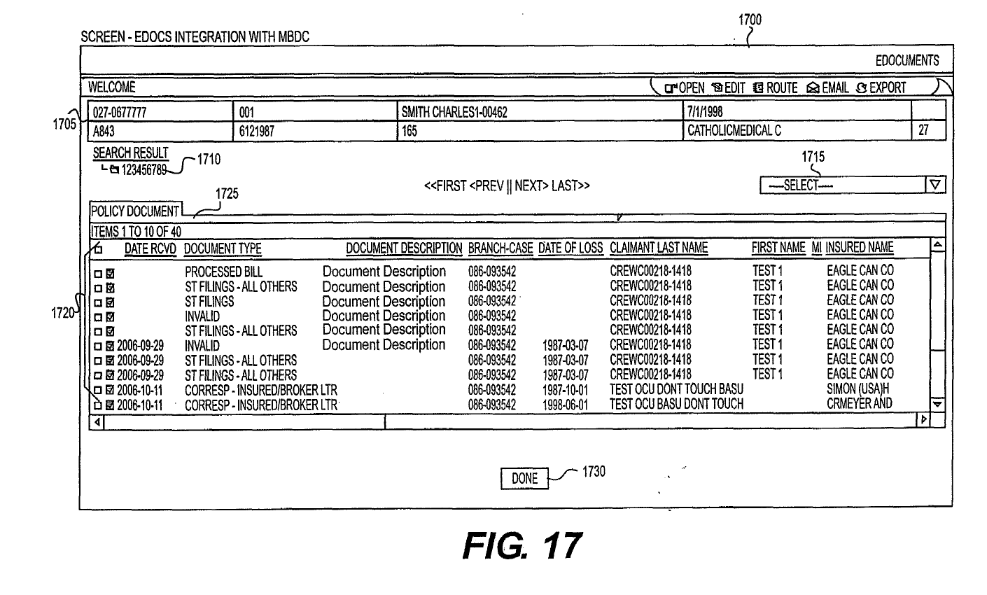

Users may display various documents through further user interfaces. FIGS. 16-17 are exemplary user interfaces for accessing integrated third party software applications that provides a user access to business process content stored in an exemplary content management system. The exemplary software applications shown in FIGS. 16-17 are third party software that is integrated with an exemplary content management system. Users can view a listing of documents (1620 and 1720), and select a subset of documents (1615 and 1715). If a claim adjuster uses such third party software to draft a report, the system can access the insurance policy from the CMS. The integrated functionality between the third party software and the CMS facilitates the workflow of the claim adjustment process by allowing contributors of the process quick, efficient access to documents from the database to complete their tasks.

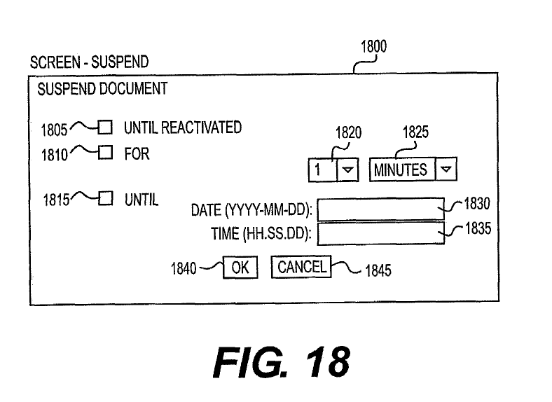

FIG. 18 is an exemplary user interface that allows the user to suspend producing business process content within an exemplary content management system. A claim process supervisor may suspend production of a document as a way to pause the process for a particular reason. For example, litigation documents may be suspended during settlement negotiations as a way to prevent additional litigation costs. The user interface is displayed upon selecting the suspend option from within dropdown list 810 (See FIG. 8). A user may select the duration of suspension. The suspension period may be until reactivated 1805, for particular length of time 1810, 1820, and 1825 or until a specific date 1815, 1830, and 1835.

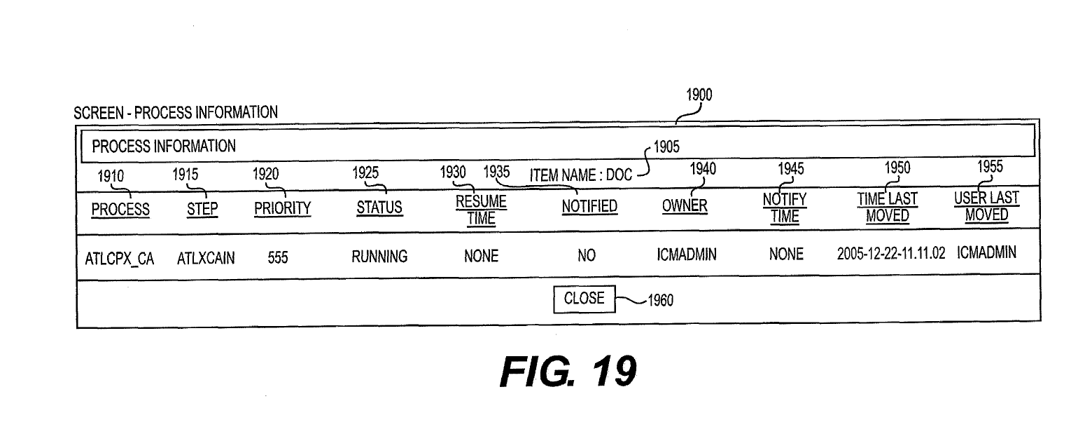

FIG. 19 is an exemplary user interface 1900 that allows a user to display process status information. A user may access this interface from the search results and worklist screens (See FIGS. 21-22 and FIG. 8) by selecting Process information from the drop down list 810 (See FIG. 8). Process information displayed includes, but is not limited to, Item Name 1905, Process Name 1910, Step 1915, Priority 1920, Status 1925, Resume Time 1930, Notified 1935, Owner 1940, Notify Time 1945, Time last Moved 1950, and User Last Moved 1955.

FIG. 8 and FIGS. 20-29 are exemplary user interfaces that illustrate aspects of the inventions, including a software application having one or more software modules that improve user efficiency and provide management functions to a user or business process participant. This includes, but is not limited to, functions such as document handling, searching, and other content managing functions that provide a cost-effective implementation of the claim adjustment process. A person of ordinary skill in the art would understand that the management functions disclosed are exemplary and do not limit aspects of the invention.

An exemplary content management system includes document handling functions and different levels of document security that allow users to effectively deal with the quantity of large documents and the sensitive nature of the documents in a claim adjustment file. Document handling functions include (but are not limited to) dividing a single document into separate parts allowing a user to send only relevant portions to another party without sending the entire document. Another document handling function combines multiple documents into one large document and/or rearranges or reorders the pages of the combined document to fit the needs of the user. In addition, a document preview function allows a user to view the first page of a document quickly instead of opening and waiting to view the entire document, which may be a time consuming process for large documents. (Documents may contain thousands of pages). Further, CMS software applications allow a user to bookmark certain sections so that a user may efficiently navigate to specific highlighted portions of a large document. Further efficiency-improving functions may include a user viewing a document by clicking on the document format icon within a worklist. In addition, attributes of a worklist may be arranged according to specific business process participant type or preference to optimize the business process participant's efficiency in completing his task for the business process.

An exemplary content management system allows users to efficiently manage the claim adjustment process by providing a document file structure within the browser tree and providing attributes to each document or work product to efficiently manage the process content. In addition, these document navigation functions allow users to understand the relationships between documents, a feature not provided by traditional content management systems. Further, users have the ability to create and name individual virtual subfolders. This allows individual users to copy all or partial documents into a subfolder without compromising the integrity of the parent claim adjustment file. A user may configure his worklist according to his preferences to maximize his efficiency in completing his tasks by configuring his user interface settings. These preferences may include the view of the worklist and the different columns shown in the worklist. For example, adjusters may view the worklist such that attributes are arranged in one way to increase efficiency in their work while payment support personnel may view the attributes in another way.

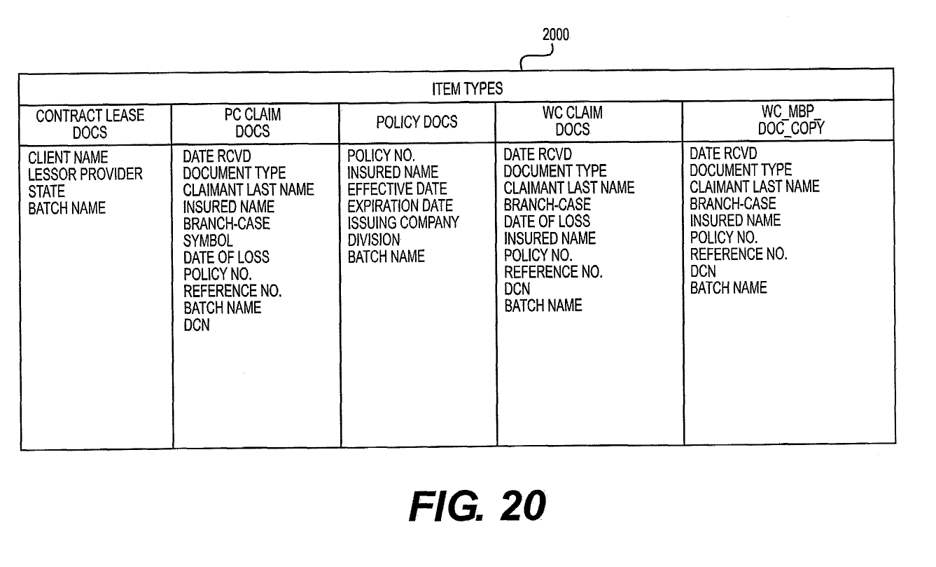

FIG. 20 is a chart of certain preferred search parameters and business process content attributes for several exemplary business process content types. A user may organize documents and other data in his worklist according to certain attributes. In addition, a user may search for documents within the content management system according to the attributes listed in FIG. 20. Further, the attributes are significant in implementing efficiency-improving and other management functions of the content management system.

FIGS. 21-22 illustrate the search functions of an exemplary content management system according to aspects of the invention. Searching by parameters or document attributes allows a user to quickly locate documents to assist completing their work product. For example, a claim analyst may search for a claim adjustment report by claim number (document attribute) and claim adjuster name (search parameter) so that she can complete her own claim analysis report.

The system and method of the present invention allows a user may need to efficiently search the documents within a claim adjustment file. A database or central repository may contain a large number of documents, each of which may be voluminous itself. To perform efficient searches, the system creates a dynamic file tag for each document, comprised of one or more meta-tags that would identify it as part of one or more groups. For example, a user is able to construct a document tag such as “item sent to a recipient X on date Y,” without changing the document type or document description attributes. This tag enables a user to execute a single search to return all associated documents for those criteria of different types and from different folders.

FIG. 21 is an exemplary user interface 2100 that allows a user to search a content management database based on preferred search parameters or attributes. A user accesses interface 2100 by clicking the Search icon 2105 in the browser tree (See FIG. 8). The user interface 2100 displays the search data entry fields for a particular claim folder (2110, 2115). In the exemplary quick search user interface 2100, search parameters include, but are not limited to, Branch-case 2145, Policy Number 2150, Insured Name 2155, Date of Loss 2160, and Reference Number.

FIG. 22 is an exemplary user interface 2200 that allows a user to select advanced techniques to search for business process content within an exemplary content management system. A user accesses the Advanced Search user interface (2200, 2207) by clicking on the Advanced Search icon 2205 within the browser tree (See FIG. 8). FIG. 22 shows several exemplary data entry fields 2250 of search parameters and document attributes that include Subfolder 2210, Branch-case 2215, Policy Number 2220, Insured Name 2225, Date of Loss 2230, Reference Number 2235 and Originator 2240. The Advanced Search user interface also allows a user to search parameters based on different logic by clicking on logic parameters in a drop down menu 2245. The different logic may include, but are not limited to, “equal,” “greater or equal to” “less than or equal to,” “not,” and “contains.”

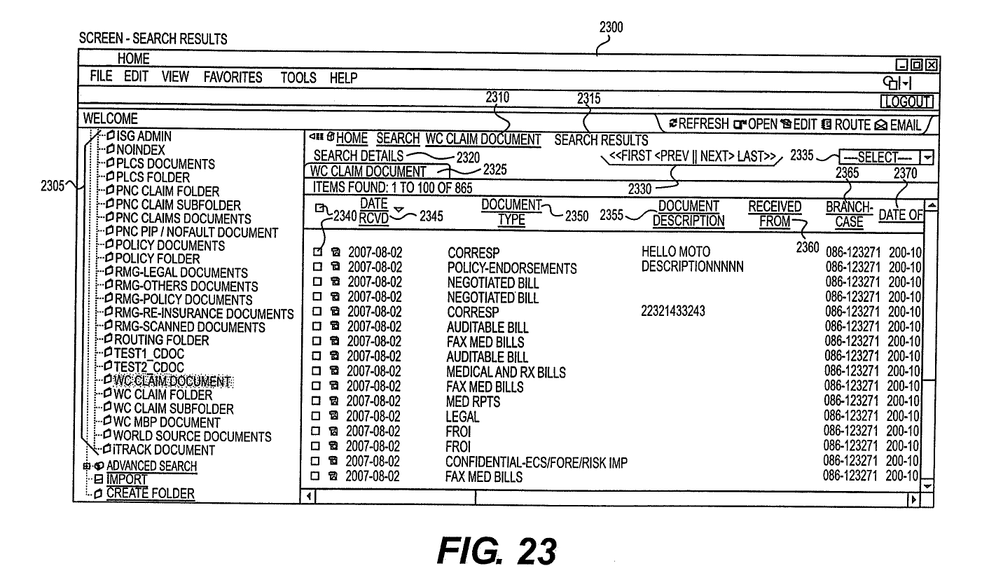

FIG. 23 is an exemplary user interface 2300 that displays exemplary search results obtained from searching an exemplary content management system, according to an aspect of the invention. The browser tree shows the claim adjustment file 2305 within which the search took place. The user interface also displays the documents 2325 within the electronic claim adjustment file that fit within the search criteria as well as each documents' attributes (2345, 2350, 2355, 2360, 2365, and 2370). A user may select one or more documents 2340 to view, edit, open, delete, route, e-mail, etc.

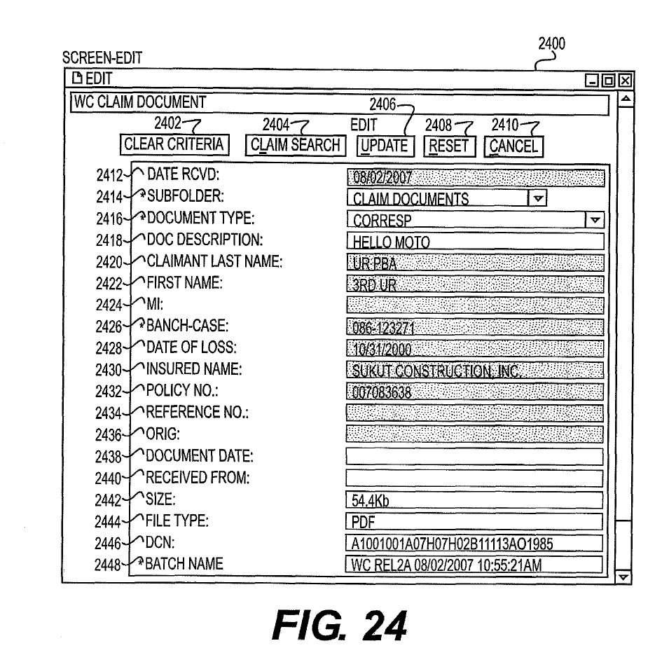

FIG. 24 is an exemplary user interface 2400 that displays attributes and allows a user to edit the attributes of a business process content stored in an exemplary content management system. A user may edit the document attributes by clicking several exemplary “push buttons” that include, but are not limited to, Clear Criteria 2402, Claim Search 2404, Update 2406, Reset 2408, and Cancel 2410. A user also may edit several exemplary attributes that include, but are not limited to, Date Received 2412, Subfolder 2414, Document Type 2416, Document Description, 2418, Claimant Last Name 2420, First Name 2422, Middle Initial 2424, Branch-Case 2426, Date of Loss 2428, Insured Name 2430, Policy Number 2432, Reference Number 2434, originator 2436, Document Date 2438, Received From 2440, Size 2442, File Type 2444, DCN 2446, and Batch Name 2448. Editing and managing document attributes provides for efficient searching of documents by the different contributors or business process participants to the claim adjustment process. In addition, editing functions with the CMS allow a user to update one or more attributes for multiple documents.

The ability to edit document attributes is particularly advantageous when it is necessary to update or correct a file. For example, a document with an incorrect claim number may be routed to an adjuster's worklist. A software application allows a claim adjuster to edit the document attributes by clearing the criteria, changing the claim number and then selecting the Claim Search pushbutton. A claim adjuster user may further edit other document attributes. To accept the attribute changes, a user will then click the Update button 2406. Further, by selecting the Update button 2406, a software application stores the document in the correct claim folder with the correct attributes. An exemplary content management system may automatically create a claim folder if one does not already exist. A notification or edit message is then routed to a user.

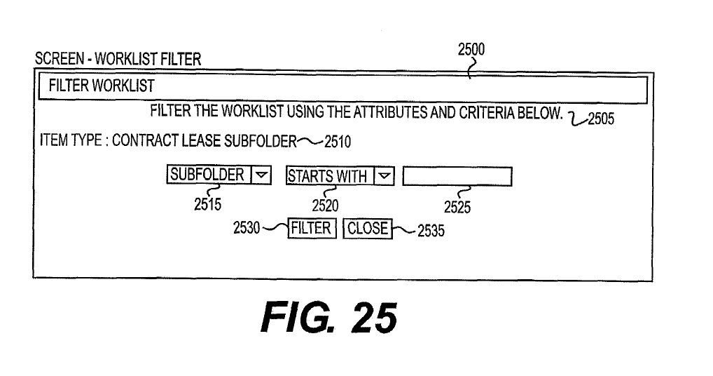

FIG. 25 is an exemplary user interface that allows a user to filter, search, and organize business process content. The user interface 2500 can be accessed by selecting the Worklist Filter option from the drop-down menu 810 on the worklist, e-docs, and search results screens (See FIGS. 8, 16-17, and 23, respectively). Filtering is performed 2530 according to the attributes and criteria (2505, 2535) selected by the user from the drop down menus (2515, 2520) and data entry field 2525.

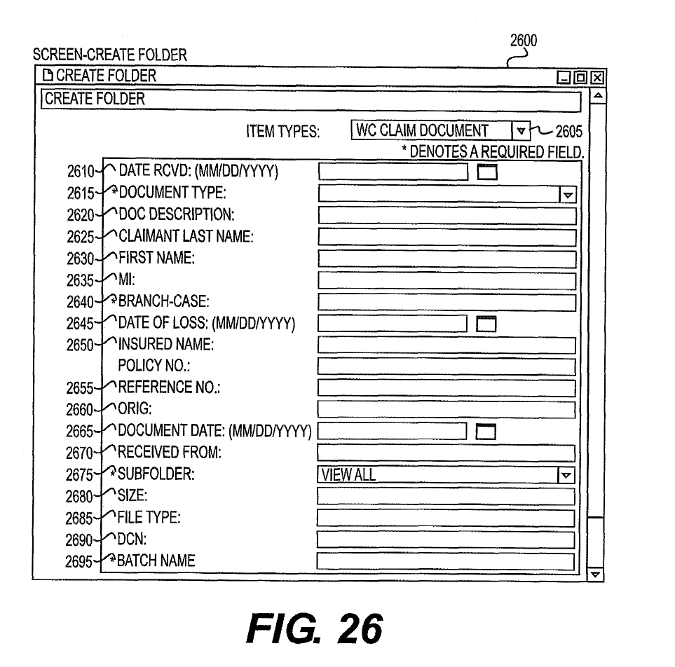

FIG. 26 is an exemplary user interface 2600 that allows a user to create an electronic folder within an exemplary content management system. A user chooses an item type from a drop down menu 2605 and then enters the necessary attribute information for the folder. This may include, but is not limited to, Date Received 2610, Document Type 2615, Document Description 2620, Claimant Last Name 2625, First name 2630, Middle Initial, 2635, Branch-case 2635, Date of Loss 2640, Insured Name 2645, Policy Number 2650, Reference Number 2655, Originator 2660, Document Date 2665, Received From 2670, Subfolder 2675, Size 2675, File Type 2680, DCN 2690, and Batch Name 2695. A user may also access the Create Folder user interface by clicking on the Create Folder icon on the browser tree. Electronic folders provide better management and organization of the claim adjustment process for an insurance company.

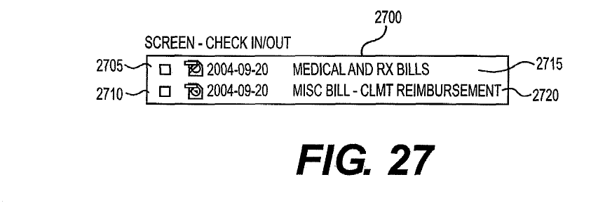

FIG. 27 is an exemplary user interface 2700 that allows a user to check-in and check-out business process content to and from an exemplary content management system. Allowing business process participant to view or edit a document at a time maintains version control and manages the claim adjustment process efficiently. For example, in a shared virtual environment where several contributors have access to file documents, duplicative or redundant changes may be incorporated into the documents. An electronic lock permits a document check-in and check-out system limits the opportunities for undesired duplicative changes. The user interface displays a check in a box (2705, 2710) in front of a document to indicate that a document (2715, 2720) is checked out. Further, the interface shows the user name who has checked out the document. In addition, a tracking mechanism is incorporated as an aspect of the invention to provide an audit trail of information regarding the circumstances under which a document has been accessed or edited.

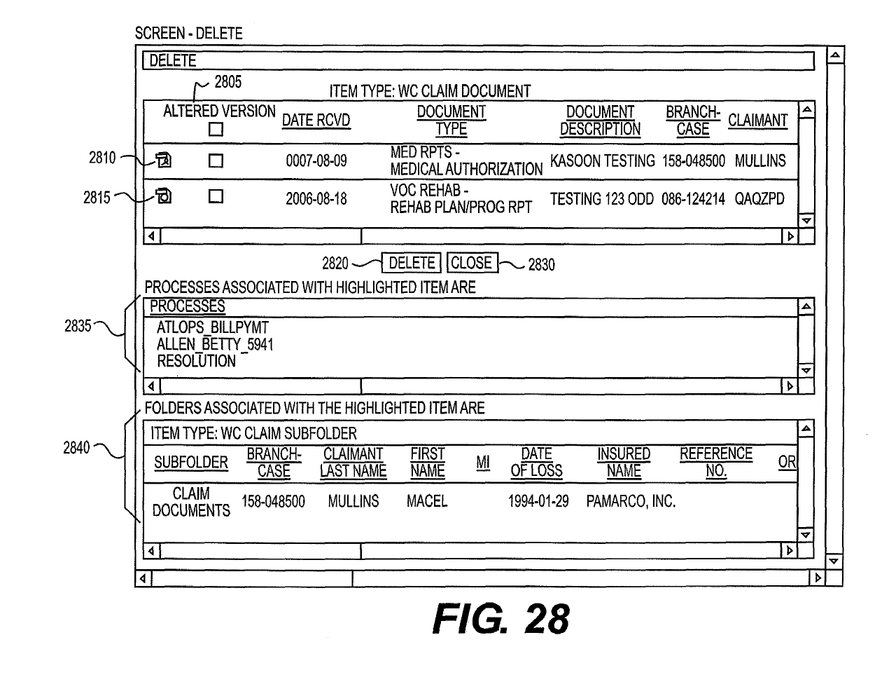

FIG. 28 is an exemplary user interface 2800 that allows a user to delete business process content from an exemplary content management system. The user interface 2800 shown in FIG. 28 is displayed upon selecting the delete option from the drop down list. The delete option 2820 is only visible to a user with delete privileges. The user interface allows the user to delete an altered version of the document 2805. It displays the documents and their attributes 2810 and 2815. Further, the user interface shows the process 2835 and subfolder 2840 associations of the documents that are to be deleted. In addition, an associations list displays each document required for the claim adjustment process before allowing a user to delete a document.

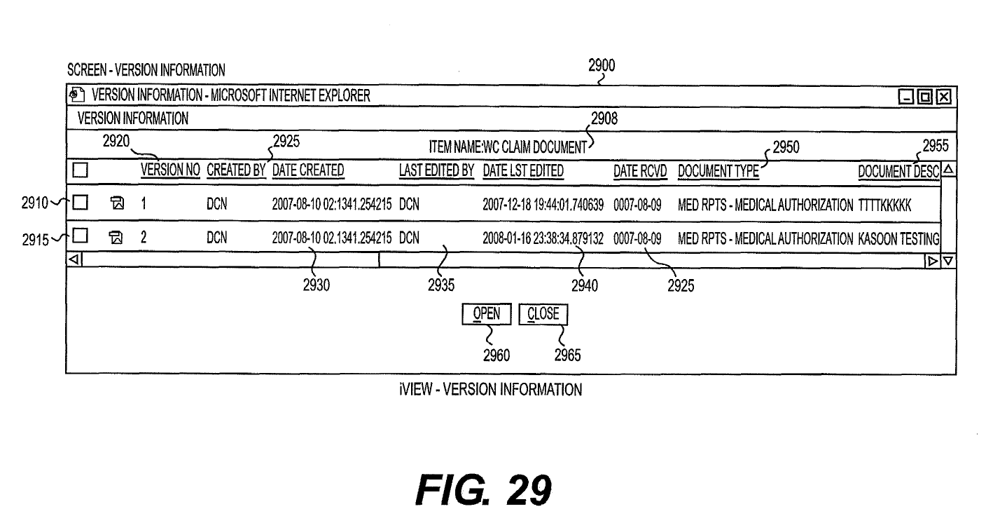

FIG. 29 is an exemplary user interface 2900 that displays the version information of business process content stored in an exemplary content management system. The user interface is displayed upon selecting the version information option from the drop down list. Different versions of a document are displayed 2910 and 2915 along with their attributes 2920, 2925, 2930, 2935, 2940, 2945, 2950, and 2955. A user may then open the select document version 2960 or close the user interface 2965.

Persons of ordinary skill in the art would understand that a database and electronic central repository store electronic information and data that includes, but is not limited to, documents, spreadsheets, audio files, video files, and image files.

Further, a person of ordinary skill in the art would understand that a contributor of a business process may include, but is not limited to, a business process participant.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A system for managing a business process and business process content, the system comprising:
a communication network;
a computer server connected to the communication network;
an electronic central repository, connected to the computer server, the computer server being programmed to store business process content files into the electronic central repository;
the computer server adapted to execute a management and workflow software application, the management and workflow software application having a management software module for accessing and organizing business process content files by a user and a workflow software module for notifying a different user to produce business process content files and routing business process content files to the different user;
the computer server further adapted to present an electronic user interface to a client over the communication network;
the computer server further adapted to receive information through the electronic user interface over the communication network;
wherein the electronic user interface, provides the user access to the management and workflow software application and business process content files stored in the electronic central repository.

2. The system according to claim 1, wherein the business process content files are selected from the group consisting of documents, spreadsheets, audio files, video files, and images files.

3. The system according to claim 2, wherein the management software module includes at least one of the following software modules:
a security software module for limiting user access to business process content files stored in the electronic central repository based on the security rights of one or more business process participants;
a check-in and check-out control software module for allowing only one of the one or more business participants access to a business process content file at a time.
a document handling software module for providing access and viewing of business process content files stored in the electronic central repository
a searching software module for providing access to business process content files based on attributes that are configurable by the user;
an organizing software module for creating folders and sub-folders to store business process content files wherein the folders and sub-folders are organized and presented as a hierarchical tree on the electronic user interface; and
an editing software module for editing one or more attributes of business process content files.

4. The system according to claim 3, wherein the workflow software module includes at least one of the following software modules:
an e-mailing software module for e-mailing business process content files to the one or more business process participants;
an exporting software module for exporting business process content files out of the system; and
an importing software module for importing and storing business process content files in the electronic central repository.

5. The system according to claim 3, wherein the document handling software module includes at least one of the following software modules:
a software module for dividing a document into a plurality of documents;
a software module for rearranging pages in the document;
a software module for combining the plurality of documents into one document;
a software module for previewing a page of the document without opening the document;
a software module for bookmarking one or more portions of the document;
a software module for annotating any type of business process content file;
a software module for tracking the user who has modified business process content files;
a software module for viewing two documents side by side within the electronic user interface;
a software module for adjusting the screen size when viewing the business process content file; and
a software module for deleting business process content files from the system.

6. The system according to claim 3, wherein a searching software module searches business process content files based on attributes using searching logic, wherein the searching logic is selected from the group consisting of Boolean logic, equal, greater or equal, less than or equal, not, and contains.

7. The system according to claim 3, wherein the organizing software module includes at least one of the following software modules:
a software module for presenting business process content files in a worklist to the user on the electronic user interface; and
a software module for presenting business process content files and business process content attributes in different arrangements according to the type or preference of the user on the electronic user interface.

8. A method for managing a business process and business process content, the method comprising:
invoking a management and workflow software application running on a computer server, the management and workflow software application having a management module and a workflow module;
generating a graphical user interface for presenting the management and workflow software application to a user;
accessing business process content files using the management module from an electronic central repository;
notifying a business process participant to produce business process content files using the workflow module;
routing business process content files to one or more business process participants using the workflow module; and
storing business process content files in the electronic central repository using the management and workflow software application.

9. The method according to claim 8, further comprising receiving and storing client business process content files in the electronic central repository.

10. The method according to claim 8, wherein the business process content files are selected from the group consisting of documents, spreadsheets, audio files, video files, and images files.

11. The method according to claim 8, further comprising accessing business process content files stored in the electronic central repository based on security rights of the user.

12. The method according to claim 8, further comprising:
e-mailing business process content files to the one or more business process participants;
exporting business process content files from the electronic central repository; and
importing business process content files into the electronic central repository.

13. The method according to claim 8, further comprising at least one of the following steps:
dividing a document into a plurality of documents;
rearranging one or more pages in the document;
combining the plurality of documents into one document;
previewing a page of the document without opening the document;
bookmarking the one or more pages of the document,
annotating any type of business content,
accessing tracking information of the one or more business process participants that modified business process content files;
viewing two documents side by side within the graphical user interface;
adjusting the screen size when viewing a business process content file on a graphical user interface; and
deleting business process content files from the electronic central repository.

14. The method according to claim 8, further comprising searching business process content files based on attributes using searching logic, wherein the searching logic is selected from the group consisting of Boolean logic, equal, greater or equal, less than or equal, not, and contains.

15. The method according to claim 8, wherein the graphical user interface, using the management and software application, presents business process content files in a worklist according to one of a plurality of arrangements selected based on a type or preference of the business process participant.

16. The method according to claim 8, further comprising accessing the management and workflow software application through a third party software application.

17. A computer-readable medium having thereon computer-executable instructions for managing a business process and business process content, the computer-executable instructions comprising:
instructions for invoking a management and workflow software application running on a computer server and having a management module and a workflow module;
instructions for generating a graphical user interface for presenting the management and workflow software application to a user;
instructions for accessing business process content files using the management module from an electronic central repository;
instructions for notifying a business process participant to produce business process content files using the workflow module;
instructions for routing business process content files to one or more business process participants using the workflow module; and
instructions for storing business process content files in the electronic central repository using the management and workflow software application.

18. The computer-readable medium according to claim 17, the computer-executable instructions further comprising:
instructions for accessing to business process content files stored in the electronic central repository based on security rights of the user.

19. The computer-readable medium according to claim 17, the computer-executable instructions further comprising:
instructions for e-mailing business process content files to the one or more business process participants;
instructions for exporting business process content files from the electronic central repository; and
instructions for importing business process content files into the electronic central repository.

20. The computer-readable medium according to claim 17, the computer-executable instructions further comprising:
instructions for dividing a document into a plurality of documents;
instructions for rearranging one or more pages in the document;
instructions for combining the plurality of documents into one document;
instructions for previewing a page of the document without opening the document;
instructions for bookmarking the one or more pages of the document,
instructions for annotating any type of business content,
instructions for accessing tracking information of the one or more business process participants that modified business process content files;
instructions for viewing two documents side by side within a graphical user interface;
instructions for adjusting the screen size when viewing the business process content file on a graphical user interface; and
instructions for deleting business process content files from the electronic central repository.

21. The computer-readable medium according to claim 17, the computer-executable instructions further comprising instructions for searching business process content files based on attributes using searching logic, wherein the searching logic is selected from the group consisting of Boolean logic, equal, greater or equal, less than or equal, not, and contains.

22. The computer-readable medium according to claim 17, wherein the graphical user interface, using the management and software application, presents business process content files in a worklist according to one of a plurality of arrangements selected based on a type or preference of the business process participant.

23. The computer-readable medium according to claim 17, the computer-executable instructions further comprising instructions for accessing the management and workflow software application through a third party software application.
